(19) United States
(12) Patent Application Publication
(10) Pub. No.: US 2004/0178970 A1
(43) Pub. Date: Sep. 16, 2004

(54) Face-mounted apparatus having spectacles and a video display integrated into the spectacles

(75) Inventors: Atika El Sayed, Levallois Perret (FR); Nicolas Paris, Nanterre (FR)

Correspondence Address: FOLEY & LARDNER, 150 EAST GILMAN STREET, P.O. BOX 1497, MADISON, WI, 53701-1497, US

(73) Assignee: Ingineo SAS

(21) Appl. No.: 10/732,914

(22) Filed: Dec. 10, 2003

Related U.S. Application Data
(63) Continuation-in-part of application No. 10/336,699, filed on Jan. 3, 2003.

(30) Foreign Application Priority Data
Dec. 10, 2002 (FR) 0215593

(51) Int. Cl. G09G 5/00

(52) U.S. Cl. 345/8

(57) ABSTRACT

A device integrated in a pair of spectacles for the diffusion of virtual images into a user's visual field superposed onto his perception of ambient images. This device includes a display unit and an optical system comprising a mirror and a terminal lens, which comprise virtual image diffusion means, assembled as a prism and attached in a mobile manner laterally to a facial mounting via a chassis which accommodates them in proximity to one another and which is arranged in a dark chamber. These arrangements are such that the virtual images are diffused biased towards the user's pupil from a lateral zone of the mounting, optimizing the use of the light intensity of the display unit.

### CROSS REFERENCE TO RELATED APPLICATIONS

The present application is a continuation-in-part application of U.S. patent application Ser. No. 10/336,699 entitled NOVEL MOBILE AUDIO VISUAL SYSTEM FOR MANAGING THE INFORMATION filed on Jan. 3, 2003. The present application claims priority to French Application No. 0215593, filed on Dec. 10, 2002.

### BACKGROUND OF THE INVENTION

1. Field of the Invention

The present invention relates generally to a face-mounted apparatus having a video display. More particularly, the present invention relates to a face-mounted apparatus having spectacles and a video display integrated into the spectacles.

2. Description of the Related Art

Devices exist that combine a screen for displaying images originating from a remote source and an optical system for sending the virtual images displayed on the screen towards a projection surface. Further, such devices exist that are attached to a facial mounting worn by a user, such as glasses or a helmet. For example, U.S. Pat. No. 5,671,037 and Application WO 9208157 describe a virtual image diffusion device having a mask completely covering the user's field of vision, in order to display virtual images on a projection surface.

German Patent DE 196 25 028 and Application WO 9923525 describe a pair of spectacles that support a virtual image diffusion device where a mirror and a lens are combined to project images originating from a display screen and reflected by the mirror. The position of the mirror in DE 196 25 028, at the front of the user's field of vision, interferes in an unwanted manner with the perception of both virtual images and ambient images.

Application WO 9923525 has an optical system that can be moved from a retracted position and an operation position. As such, the optical system is respectively moved away from, and placed in, the user's field of vision. The optical pivots on a support of an arm of the facial mounting, so that it can be placed in the operating position parallel to and in front of an eyeglass of the latter. Application WO 9923525 projects virtual images directly towards the user's pupil, and not onto a screen interposed in the field of vision of the ambient images as is described in German Patent DE 19625028. However, the frontal arrangement in the operating position of the optical system and its support causes interference with both the virtual images and ambient environment perceived by the user.

### SUMMARY OF THE INVENTION

Briefly summarized, an embodiment of the invention may be found in an apparatus and/or a system for diffusing virtual images into a user's visual field, superposed onto his perception of ambient images, that optimizes the perception by the user of both virtual and ambient images and reduces unwanted visual interference between these images, with a view to increasing visual comfort.

An exemplary embodiment relates to an apparatus which diffuses virtual images into a user's visual field, superposed onto his perception of ambient images of the environment in which he finds himself. The apparatus comprises a virtual image diffusion means in relation with a remote image-producing source. The virtual image diffusion means are attached to a facial mounting, such as the mounting of a pair of spectacles, a helmet or similar, and combine a unit for displaying the virtual images produced, such as a screen or similar, and an optical system for resending towards the user's pupil, virtual images displayed by the display unit. The optical system comprises at least one mirror reflecting the images displayed by the display unit towards a terminal lens for projection of the reflected images.

### BRIEF DESCRIPTION OF DRAWINGS

The present invention will be better understood, and relevant details will appear, with reference to the description to be made of exemplary embodiments, in relation to the Figures in the attached pages in which:

FIG. 1 is a general diagram of a device according to an exemplary embodiment of the present invention.

FIG. 2 is an exploded view of an optoelectronic system of a display module carried by a pair of spectacles.

FIG. 3 is a representation of an optoelectronic system in accordance with an exemplary embodiment and its arrangement on or in a case.

FIG. 4 is a perspective illustration of a facial mounting according to an exemplary embodiment.

FIG. 5 is a cross-section illustration through a section of the facial mounting represented in FIG. 1.

FIG. 6 is a top view of the facial mounting represented in FIG. 1 where a display module is located at a minimum angle of sight in accordance with an exemplary embodiment.

FIG. 7 is a top view of the facial mounting represented in FIG. 1 where a display module is located at a maximum angle of sight in accordance with another exemplary embodiment.

FIG. 8 is a top view of a facial mounting according to an alternative embodiment where a display module is located at a minimum angle of sight.

FIG. 9 is a top view of a facial mounting according to an alternative embodiment where a display module is located at a maximum angle of sight.

FIG. 10 is a top cut-out view of the facial mounting of FIG. 8 in accordance with an exemplary embodiment.

FIG. 11 is a side view of the facial mounting of FIG. 8 in accordance with an exemplary embodiment.

FIG. 12 is a front view of the facial mounting of FIG. 8 in accordance with an exemplary embodiment.

FIG. 13 is a top view of the facial mounting of FIG. 8 in accordance with an exemplary embodiment.

FIG. 14 is a perspective view of the facial mounting of FIG. 8 in accordance with an exemplary embodiment.

### DETAILED DESCRIPTION OF EXEMPLARY EMBODIMENTS

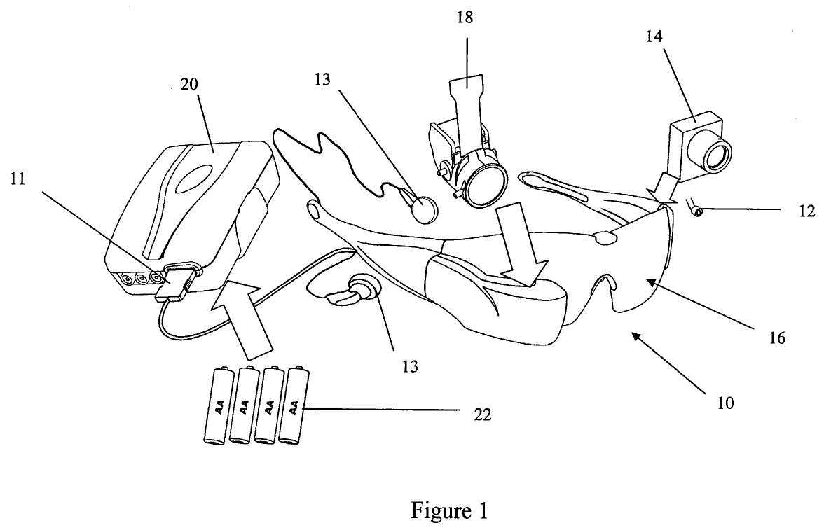

FIG. 1 illustrates an apparatus 10 including a connector 11, a microphone 12, an earphone 13, a micro camera 14, and a pair of spectacles 16 including a display module 18. The connector 11 can be a video connector or a combined audio and video connector that couples to a control unit 20. The control unit 20 includes an energy source 22 (e.g., a battery or batteries).

In an exemplary embodiment, the apparatus 10 retains a user's frontal field of vision to the natural perception of ambient images by laterally offseting on the display module 18 so that it does not constitute a frontal obstacle to his field of vision. This lateral offset allows the user to look straight towards the front of his visual field, in order to clearly perceive not only his natural environment, but also the virtual images which are projected laterally towards his pupil.

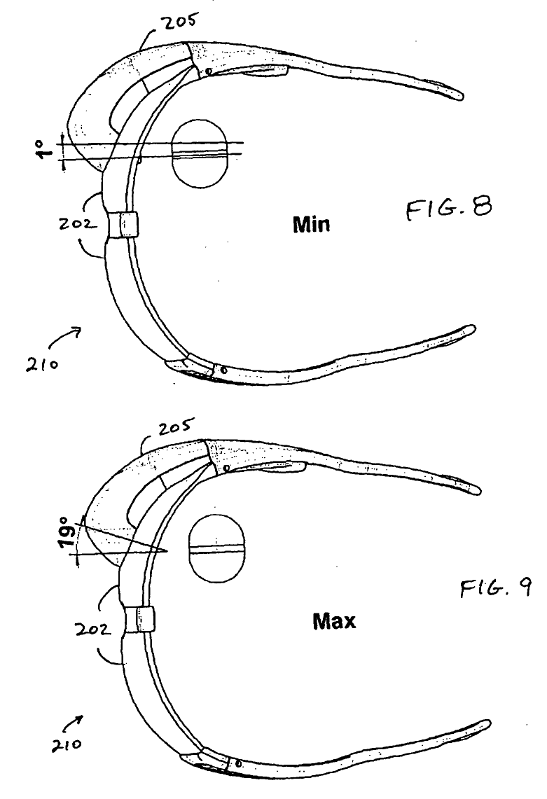

Alternatively, the display module 18 can be offset horizontally instead of laterally. A horizontal offset would also provide an unobstructed field of vision for at least a portion of the visual field. The horizontal offset can be accompanied by a lateral offset. FIGS. 8-16 describe an apparatus according to such an alternative embodiment.

The apparatus 10 uses spectacles 16 that can be of varying shapes and sizes. It visualizes information via a miniaturized screen in the display module 18 and an optical system that resends an image towards the user's eye, thus creating the illusion of a virtual screen floating in the user's field of vision. The apparatus 10 can be monocular or binocular and does not notably obstruct the user's field of vision. The display module 18 can be positioned on the right or on the left of the mounting. Audio can be heard using earphones 13 and recorded using the microphone 12. Video can be recorded using micro camera 14. The apparatus 10 allows the screen of the display module 18 to be positioned in several places in the field of vision on the horizontal and vertical and depth planes.

The apparatus 10 can receive input from a variety of different input devices and systems. For example, the apparatus 10 can receive input from a voice recognition system, a barcode reader, video, and audio. In a voice recognition system, voice commands can be used in place of a keyboard, mouse, or other input device.

The apparatus 10 is connected to the control unit 20 in order to receive information. This control unit 20 can take several forms, such as office computers, portable computers, wearable personal computers, personal digital assistants, television, video cassette recorder, DVDs, cameras, multimedia apparatus, photographic, and recording equipment. The control unit 20 can be located at a fixed place or be carried by the user. The spectacles 16 include a facial mounting intended to be held on the user's face, one or more screens which can provide correction of vision and/or solar protection, and arms which are fitted to the mounting and resting on the user's ears.

The apparatus 10 allows the user to visualize information coming from an external source according to an identified mode. In an exemplary embodiment, the display module 18 presents a screen appearing to float before his eyes (right or left or both) situated starting 15° from the outer field of vision (from the pupil) and displaced up to 30° to 40° in order to respect the useful field of vision (which serves as the “working” zone of vision and a “normal” rotation of the eye (0 to 15°). The display module 18 can also be adjusted on the vertical plane in a field 15° above and below the eye's field of vision. The elevation and azimuth adjustment of the display module 18 device can be carried out in the vertical and horizontal planes. The depth can also be adjusted.

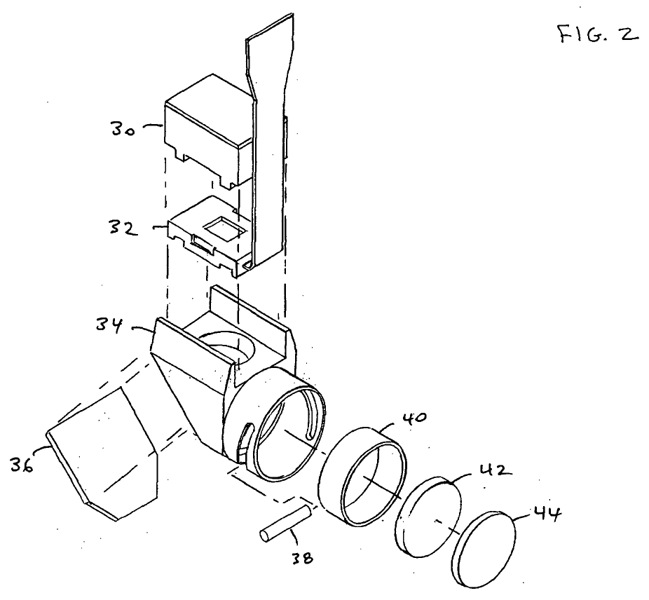

FIG. 2 illustrates an opto-electronic system included in the display module 18 carried by a spectacle arm including a light source 30, a micro display 32, the main housing 34 and a retractable mirror 36, a sleeve 38 for adjusting the focusing, a cylindrical lens cell 40, a spherical lens 42, and a spherical lens 44.

The micro display 32 can present text displays, such as procedures, commands, messaging, address books, information on work, SMS, meetings, tasks, and agendas. The micro display 32 can present displays of diagrams, such as control plans, graphic diagrams, technical reference systems, and road maps. The micro display 32 can also present displays of images, such as medical images, photos, books, tables, Internet, online commands, information retrieval, and television. Further, the micro display 32 can present video displays, such as Webcams, films, replication of displays from several cameras, face recognition, GPS, and video conferencing.

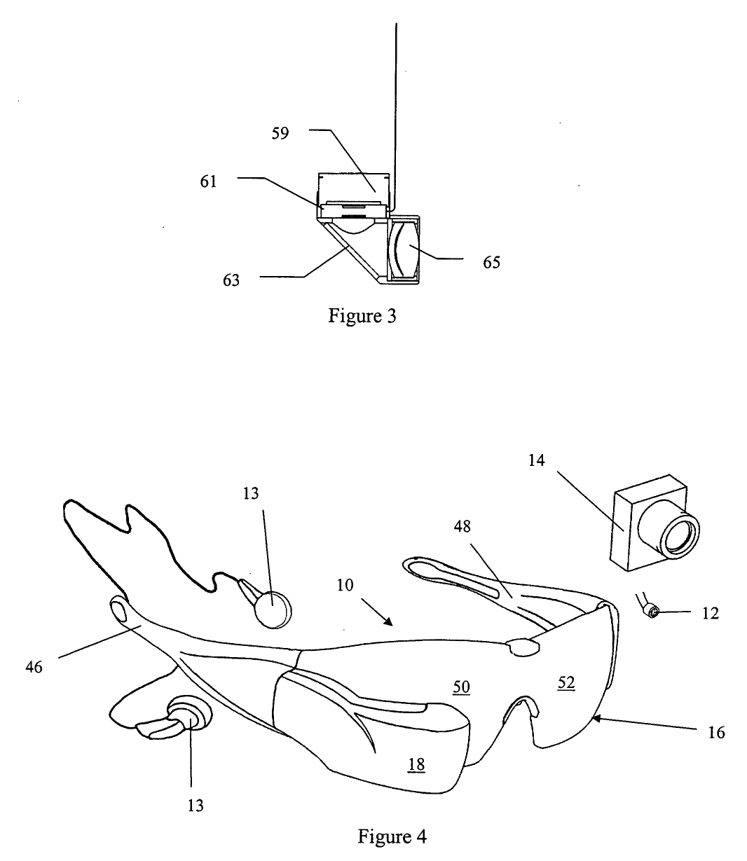

FIG. 3 shows diagrammatically an opto-electronic system of apparatus 10 and its arrangement in an optical module of the display module 18. A source 59, screen 61, mirror 63, and terminal lens 65 attached laterally to the facial mounting and are oriented in relation to each other to form a prism, the edges of which are approximately defined by their corresponding edges. These arrangements allow a diffusion biased towards the user's pupil of the virtual images projected by the terminal lens 65, from a lateral zone of the mounting.

The source 59 can include a flat liquid crystal screen or any available screen using another technology, and a backlighting module making it possible to generate a light source (in the case of an LCD screen). The source 59 is coupled to an electronic system making it possible to generate the display of information on the screen and the backlighting of the latter. The screen 61 and overall plane of the terminal lens 65 together define an approximate right angle, whilst the mirror 63 is approximately inclined at 45° with respect to the screen 61 and the overall plane of the terminal lens 65.

All or part of the associated electronics are accommodated in one of the arms of the spectacles 16. The electronic modules integrated in the arm of the spectacles are connected to the control unit 20 by wire or wireless route. The control unit 20 includes a case integrating electronic modules (e.g., signal conversion, signal processing). The control unit 20 can include display adjustment controls (e.g., brightness, contrast and other adjustments). The control unit 20 can also be connected to the spectacles 16 by a wireless system allowing the exchange of information between the electronic elements fixed onto the spectacles and the electronic elements in the control unit 20. Moreover, the control unit 20 can contain an autonomous power supply device serving to generate the energy necessary for the operation of the electronic components which it contains, and those of the spectacles.

Moreover, the apparatus 10 can have accessories added, such as an accessory for adjusting the focal distance equipping the terminal lens 65, without inducing a risk of interference with the ambient images. Similarly, the display module 18 is capable of being equipped with an accessory for adjusting the luminosity of the images which it diffuses without affecting the user's perception of the ambient and virtual images.

In FIG. 4, the apparatus 10 includes spectacles 16 having two curved, slightly flattened arms 46 and 48, two glasses for natural vision 50 and 52, and on one of the glasses fixed on the edge of the mounting, the display module 18. The user can perceive the real image and the image which is transmitted to him without deformation and without delay in transmission. By integrating a micro camera 114 in the display module 18, the user can also film what he is seeing.

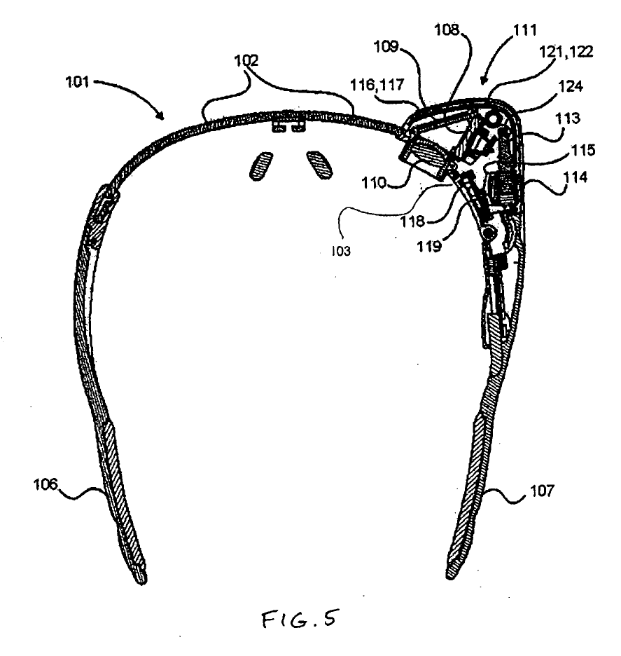

FIG. 5 illustrates an alternative embodiment in which an apparatus 101 allows a user to perceive, in superposition, ambient images of the environment in which he finds himself, and virtual images originating from a source. The ambient images are perceived by the user through the eyeglasses 102 according to the natural frontal direction of vision. The virtual images are conveyed to a lateral zone 103 of the apparatus 101, from the source via a cable or similar connected to a screen 108, a mirror 109, and a terminal lens 110. The screen 108, mirror 109, and terminal lens 110 are attached to the lateral zone 103 of the apparatus 101 for biased diffusion of virtual images directly towards the user's pupil. In an alternative embodiment, the two arms 106 and 107 of the apparatus 101 are each capable of receiving the screen 108, mirror 109, and terminal lens 110 in the case where three-dimensional perception of these images is sought.

The screen 108 and the overall plane of the lens 110 together define an approximate right angle, while the mirror 109 is approximately inclined at 45° with respect to the screen 108 and the overall plane of the lens 110. This arrangement of the screen 108, mirror 109, and lens 110 makes it possible to be positioned in the lateral zone 103 of the apparatus 101, and which makes it possible to take advantage of their proximity in order to arrange their confinement inside a dark chamber 111 optimizing the use of the light intensity of the display screen 108.

The dark chamber 111 is composed of two half-shells 121 and 122 fitted together by interlocking, which between themselves accommodate the display screen 108, mirror 109, and lens 110. The dark chamber 111 includes clearances to allow respectively the lateral emergence of the lens 110, and access to the rear surface of the display screen 108 with a view to its connection to the remote image-producing source 104, via an interposed electronic proximity circuit 118.

The dark chamber 111, the mirror 109, and the terminal lens 110 are preferably carried together by a chassis attached to the mounting. These arrangements are such that the mounting is advantageously equipped to adjust the position of the image projected towards the user's pupil. The presence of a dark chamber has the advantage chiefly of providing enhanced contrast of the virtual image, which is not the case with conventional systems where the virtual image is distinctly less visible due to the fact that this image is taken to the end of a prism which is open to the air.

The dark chamber 111 is mounted in a pivoting manner 124 on one of the ends of a finger 113 the other end of which revolves by screwing inside a toothed wheel 114. The toothed wheel 114 is mounted in a turning manner in a reception cage 115 forming part of a protective case comprising two half-shells 116 and 117 assembled together by interlocking, which envelope the dark chamber 111 accommodating the display screen 108, mirror 109, and lens 110 and the electronic proximity circuit 118.

An action on the toothed wheel 114 by the user causes a displacement of the finger 113 inside the toothed wheel 114, which itself causes a pivoting of the dark chamber 111 about its pivot pin 124. As the dark chamber 111 carries the lens 110 for projecting the virtual images, the orientation of this projection lens 110 is modified starting from a corresponding operation carried out by the user on the toothed wheel 114, in order to diffuse the virtual images towards the pupil, according to a variably biased orientation freely chosen by the user, within a range of variation of between 10° and 20°, for example. The lens 110 is equipped with a sleeve for adjusting its focal length in order to facilitate the focussing of the virtual images which it projects towards the user's pupil.

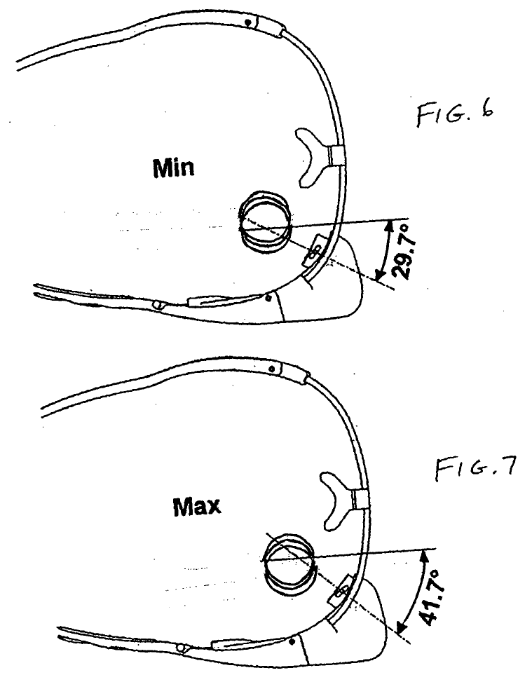

FIG. 6 illustrates a top view of the apparatus 10 described with reference to FIGS. 1-4. In an exemplary embodiment, the micro display 32 of the display module 18 is located at a minimum angle of sight, such as 29.7° , from a straight line extending from the user's eye. FIG. 7 illustrates a top view of the apparatus 10 where the micro display 32 is located at a maximum angle of sight, such as 41.7°, from a straight line extending from the user's eye.

The location and positioning of display module 18 and micro display 32 can be changed in accordance with alternative embodiments. For example, FIG. 8 illustrates a top view of an apparatus 210 where a display 212 is located at a minimum angle of sight, such as 1°. In this embodiment, display module 205 can be located at a lower portion of spectacles 202. FIG. 9 illustrates a top view of the apparatus 210 where the display 212 is located at a maximum angle of sight, such as 19°.

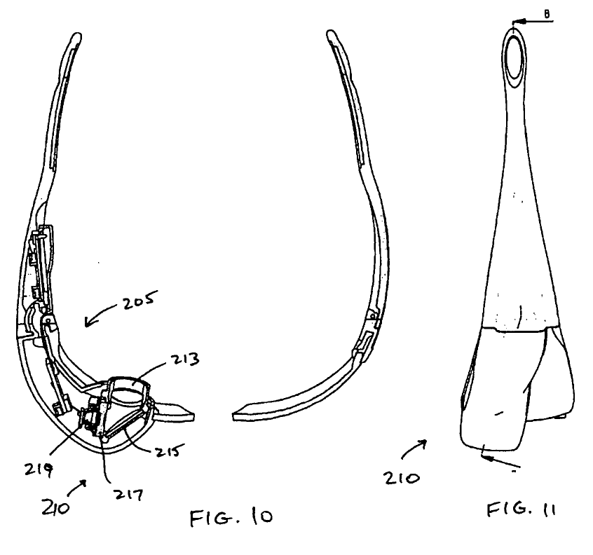

FIG. 10 illustrates a top cut-out view of the apparatus 210. Apparatus 210 includes a display module 205 having a terminal lens 213, a mirror 215, a screen 217, and a source 219. The terminal lens 213, mirror 215, screen 217, and source 219 as well as other components of the display module 205 are similar to the components of the display modules of apparatus 10 described with reference to FIGS. 1-4, 6, and 7 and apparatus 101 described with reference to FIG. 5.

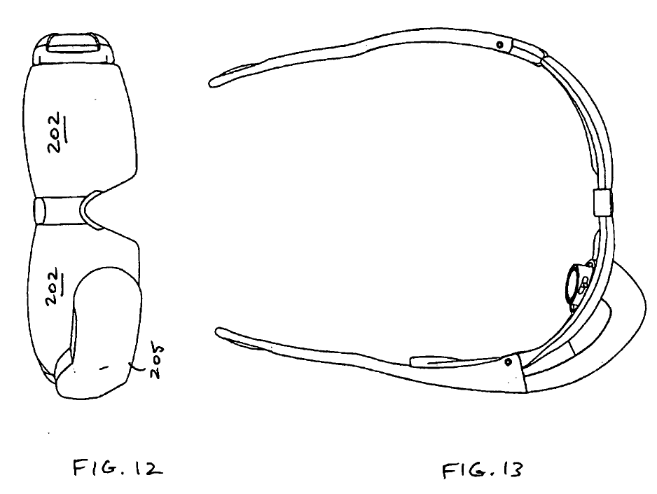

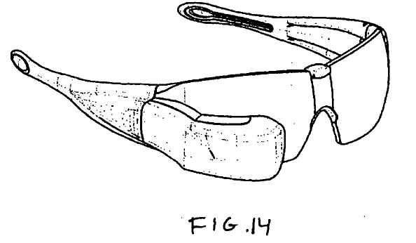

FIG. 11 illustrates a side view of the apparatus 210. FIG. 12 illustrates a front view of the apparatus 210. As shown in FIG. 12, the display module 205 is positioned at a lower half of spectacles 202. This positioning allows the user to have a full field of view via the top half of the spectacles 202. FIG. 13 illustrates a top view of the apparatus 210 and FIG. 14 illustrates a perspective view of the apparatus 210.

Some of the advantages of the exemplary embodiments described with reference to the Figures include the following. The apparatus has increased mechanical stability, and in particular without an attached mobile piece, and therefore the optical module is always in the correct position in front of the observer's eye. The apparatus is easily adjusted as controls are simple, direct and integrated, which makes them easy to operate. The apparatus has a virtual image which is well contrasted, as it is inserted into a black chamber integrated in the mounting. The apparatus has improved ergonomics and comfort compared to conventional devices. The construction of the apparatus has a spectacles mounting, with arms that close or fold up in order to allow the product to be folded away in a case which can be placed, for example, in the pocket of a garment.

While several embodiments of the invention have been described, it is to be understood that modifications and changes will occur to those skilled in the art to which the invention pertains. Accordingly, the claims appended to this specification are intended to define the invention precisely.

1. A face-mounted apparatus having spectacles and a video display integrated into the spectacles, the apparatus comprising:
an image-producing source; and
a virtual image diffuser having a display, a mirror, and a terminal lens, the virtual image diffuser being attached to a facial mounting and displaying virtual images from the image-producing source,
wherein the virtual image diffuser is positioned on the facial mounting away from a main line of sight of a user, the virtual image diffuser directing a biased diffusion towards the user's pupil of virtual images projected by the terminal lens.

2. The apparatus of claim 1, wherein the display, the mirror, and the terminal lens are together carried by a chassis attached to a mounting such that the mounting is equipped with a mechanism for adjusting the position of the image projected towards the user's pupil, starting from a displacement of the virtual image diffuser.

3. The apparatus of claim 2, wherein the chassis is arranged in an envelope inside which the display, the mirror, and the terminal lens are attached, such that the chassis is arranged in a dark chamber inside which the virtual image diffuser are assembled in proximity to one another.

4. The apparatus of claim 3, wherein the dark chamber is composed of two half-shells joined together by interlocking, and which accommodate between them the display, mirror, and terminal lens.

5. The apparatus of claim 1, wherein the virtual image diffuser is oriented between 29.7° and 41.7° laterally off of the main line of sight.

6. The apparatus of claim 1, wherein the virtual image diffuser is oriented between 1° and 19° laterally off of the main line of sight and in a lower half of the facial mounting.

7. The apparatus of claim 1, wherein the terminal lens is equipped with a mechanism for adjusting its focal length.

8. The apparatus of claim 1, further comprising a support unit arranged in a case of two half-shells joined together by interlocking to envelope the virtual image diffuser.

9. The apparatus of claim 1, further comprising a audio connector which receives audio from a control unit.

10. The apparatus of claim 1, further comprising a control unit including a power source.

11. The apparatus of claim 2, wherein the mechanism for adjusting the position of the image projected towards the user's pupil includes a knob.

12. The apparatus of claim 2, wherein mechanism for adjusting the position of the image projected towards the user's pupil comprises pre-defined notches in the chassis.
